(19) United States
(12) Patent Application Publication
(10) Pub. No.: US 2011/0184781 A1
(43) Pub. Date: Jul. 28, 2011

(54) Tracking of Patient Satisfaction Levels within a Healthcare Facility

(76) Inventors: Ali Adel Hussam, Columbia, MO (US); Mike West, Philadelphia, PA (US)

(21) Appl. No.: 13/069,353

(22) Filed: Mar. 22, 2011

Related U.S. Application Data
(63) Continuation-in-part of application No. 12/699,522, filed on Feb. 3, 2010.
(60) Provisional application No. 61/253,398, filed on Oct. 20, 2009.
(60) Provisional application No. 61/413,692, filed on Nov. 15, 2010.

(51) Int. Cl. G06Q 10/00

(52) U.S. Cl. 705/7.32

(57) ABSTRACT

A computer-implemented method includes tracking by one or more computer systems a user's satisfaction level with a medical service; determining by the one or more computer systems that the user's satisfaction level is below a threshold value; causing by the one or more computer systems one or more processes to be implemented to increase the user's satisfaction level above the threshold value; determining by the one or more computer systems that the user's satisfaction level is above the threshold value; and causing by the one or more computer systems information indicative of the user's satisfaction level to be sent to a data reporting system.

### CLAIM OF PRIORITY

This application is a continuation-in-part and claims priority under 35 U.S.C. §120 to U.S. patent application Ser. No. 12/699,522, filed on Feb. 3, 2010, which in turn claims priority under 35 U.S. §119(e) to provisional U.S. Patent Application 61/253,398, filed on Oct. 20, 2009, the entire contents of each of which are hereby incorporated by reference. This application also claims priority under 35 U.S.C. §119(e) to provisional U.S. Patent Application 61/413,692, filed on Nov. 15, 2010, the entire contents of which are also incorporated herein by reference.

### BACKGROUND

Medical forms are used to collect data and information regarding a patient's symptoms and conditions. One technique for preparing a medical form is to manually edit a pre-existing form (e.g., a form existing in Microsoft Word™ format) with new or customized questions. The form is then sent to review boards for review through a physical or electronic mailing. Additionally, once a form has been finalized, it may be presented to a patient, study participant or other individual (collectively referred to as “patients” herein, without limitation, for purposes of convenience). For example, physicians may present patients with the forms when the patient visits the physician's office. Additionally, hardcopy (i.e., paper) versions of medical forms may be distributed to patients for completion. For patients who have not completed medical forms prior to the patient's examination, the patient may often complete the medical form at the physician's office by filling out a hardcopy of the form.

Frequently, the patient's responses to the questions included in the medical forms are entered into a computerized system by medical personnel. In this case, in order for a physician to review the patient's responses, the physician may access the computerized system and view the answers to the questions, which is often a lengthy process of reviewing individual questions.

### SUMMARY

In one aspect of the present disclosure, a computer-implemented method includes tracking by one or more computer systems a user's satisfaction level with a medical service; determining by the one or more computer systems that the user's satisfaction level is below a threshold value; causing by the one or more computer systems one or more processes to be implemented to increase the user's satisfaction level above the threshold value; determining by the one or more computer systems that the user's satisfaction level is above the threshold value; and causing by the one or more computer systems information indicative of the user's satisfaction level to be sent to a data reporting system.

Implementations of the disclosure may include one or more of the following features. In some implementations, the one or more processes include notifying an entity associated with the medical service that the user's satisfaction level with the medical service is below the threshold value. In other implementations, the method also includes receiving a notification that the entity has performed one or more follow-up actions to increase the user's satisfaction level with the medical service.

In still other implementations, the method includes sending, to a computer system associated with the user, a request for the user to re-submit information indicative of the user's satisfaction level with the medical service. In other implementations, the method includes generating, by the one or more computer systems, a user satisfaction survey; sending, by the one or more computers, the user satisfaction survey to the user that received the medical service; and receiving information indicative of answers to questions included in the user satisfaction survey. In yet other implementations, the method includes analyzing by the one or more computers information included in the user satisfaction survey; determining that at least a portion of the information included in the user satisfaction survey pertains to the medical service; generating a quality score for the portion of the information that pertains to the medical service; comparing the quality score to the threshold value; and determining, based on comparing, that the quality score is below the threshold value.

In another aspect of the disclosure, one or more machine-readable media are configured to store instructions that are executable by one or more processing devices to perform operations including tracking a user's satisfaction level with a medical service; determining that the user's satisfaction level is below a threshold value; causing one or more processes to be implemented to increase the user's satisfaction level above the threshold value; determining that the user's satisfaction level is above the threshold value; and causing information indicative of the user's satisfaction level to be sent to a data reporting system. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform operations including: tracking a user's satisfaction level with a medical service; determining that the user's satisfaction level is below a threshold value; causing one or more processes to be implemented to increase the user's satisfaction level above the threshold value; determining that the user's satisfaction level is above the threshold value; and causing information indicative of the user's satisfaction level to be sent to a data reporting system. Implementations of this aspect of the present disclosure can include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE FIGURES

FIG. 1 is a conceptual diagram of a system that tracks patient satisfaction levels within a healthcare facility.

FIG. 2 is a block diagram of components of the system that tracks patient satisfaction levels within a healthcare facility.

FIG. 3 is a flow chart of a process for tracking patient satisfaction levels within a healthcare facility.

FIGS. 4-6 are screen shots of graphical user interfaces associated with tracking patient satisfaction levels within a healthcare facility.

Like reference symbols in the various drawings indicate like elements.

### DETAILED DESCRIPTION

The system described herein may be used to collect data indicative of a user's experience and/or satisfaction level in a healthcare facility (e.g., the appearance of the healthcare facility, the staff of the healthcare facility), with a healthcare professional, with a healthcare procedure, with a health care service, and so forth (collectively referred to herein as a “healthcare facility,” without limitation, for purposes of convenience). While the examples described herein may pertain to a healthcare facility, the techniques described herein are generally applicable in other contexts pertaining to a healthcare facility.

In an exemplary embodiment described herein, the user's satisfaction level may pertain to a particular unit within a healthcare facility, including, e.g., a surgical unit, a maternity unit, an intensive care unit, and so forth. In an example, if a patient had surgery, the patient may provide a ranking of the patient's surgical experience (e.g., with the procedure itself, with the staff that performed the procedure, with an appearance of the surgical facility, and so forth). In another example, the user's satisfaction level may pertain to a particular portion of the user's anatomy (e.g., shoulder, hand, chest, and so forth) in which the patient received medical attention. In this example, a patient visits a clinic to have pain in the patient's shoulder treated. Numerous departments within the clinic provide care to the patient. The patient submits to the system information specifying the user's level of satisfaction with the care and/or with each department that provided the healthcare.

In the exemplary embodiment described herein, the system is configured to measure the user's satisfaction level against a predefined threshold. In an example, the system is configured to determine the user's satisfaction level based on the user's answers to questions included in a patient questionnaire. When the system detects that the user's actual satisfaction level is below the predefined threshold, the system implements numerous policies and processes to increase the user's satisfaction level. In an example, the system generates a graphical user interface that provides an “automated dashboard” of alerts that visually alert the staff in the healthcare facility that the user's actual satisfaction level is below the predefined threshold. In this example, through the dashboard, the staff can contact the user, e.g., through email, text and telephone calls to engage with the user and to resolve the problem and to follow-up with the user to ensure that the problem has been resolved. Generally, a dashboard includes a graphical user interface that organizes and presents information in a way that is easy to read.

In an example, the dashboard displays real-time alerts, for example, as the system in real-time determines that a patients satisfaction level has dropped below the threshold level. Additionally, as described herein, the dashboard may be used to resolve alerts, for example, by contacting the user to resolve the problem and immediately after contacting the user (and resolving the problem) prompting the user to fill out another user questionnaire to reflect the user's new, increased level of satisfaction. When an alert is resolved, the alert is archived, e.g., by being stored in a data repository, and the system updates a status of the alert from “active” to “inactive.” When the alert is associated with a status of active, the alert still needs to be addressed by staff member of the health care facility. When the alert is associated with a status of inactive, the alert has been addressed by the staff member and the user's problem has been resolved. However, the alert is archived, for example, to be accessible at a later point in time for reporting purpose, including, e.g., the type of problem the user encounter, the amount of time it took to resolve the problem, a department within the medical facility that encountered the problem, and so forth.

In another example, the system pages or otherwise notifies healthcare providers to follow-up with a patient that has indicated a satisfaction level below the predefined threshold. In this example, the healthcare providers or the automated engine follow-up with the patient to provide additional care and/or counseling to the patient. In response to the follow-up, the system may again request that the user submit another satisfaction survey to provide the system with information indicative of the user's satisfaction level. The system may perform the foregoing actions iteratively until the system detects a satisfaction level that is above the predefined threshold.

Upon detection that the satisfaction level is above a predefined threshold, the system may be configured to export satisfaction results to an external, third-party data collection system that externally ranks healthcare facility. In another example, upon detection that the satisfaction level is above a predefined threshold, the system is configured to prompt the user to report the user's satisfaction to the external, third-party data collection system.

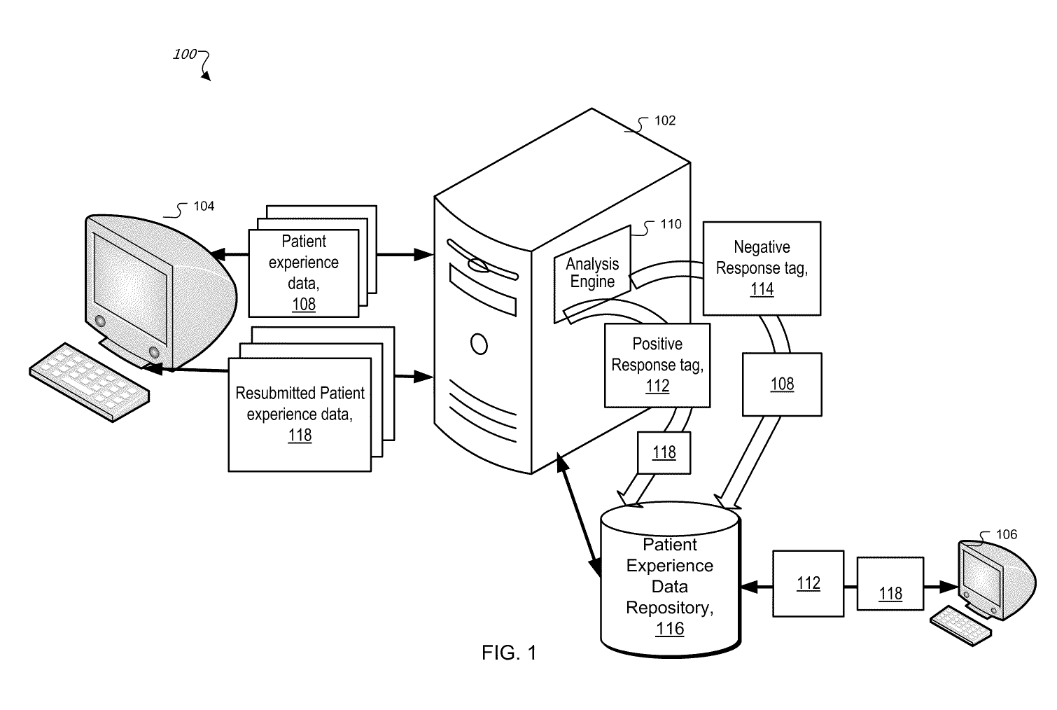

FIG. 1 illustrates a particular exemplary embodiment described herein. In particular, FIG. 1 is a conceptual diagram of system 100 that tracks patient satisfaction levels within a healthcare facility. In the example of FIG. 1, system 100 includes server 102 and client device 104. Client device 104 may be used to collect patient experience data 108, for example, using questionnaires as described in U.S. Ser. No. 12/699,522. In an example, patient experience data 108 includes information indicative of a patient's satisfaction with a medical procedure at a healthcare facility, medical care at a healthcare facility, experience at a healthcare facility, and so forth. Client device 104 sends patient experience data 108 to server 102.

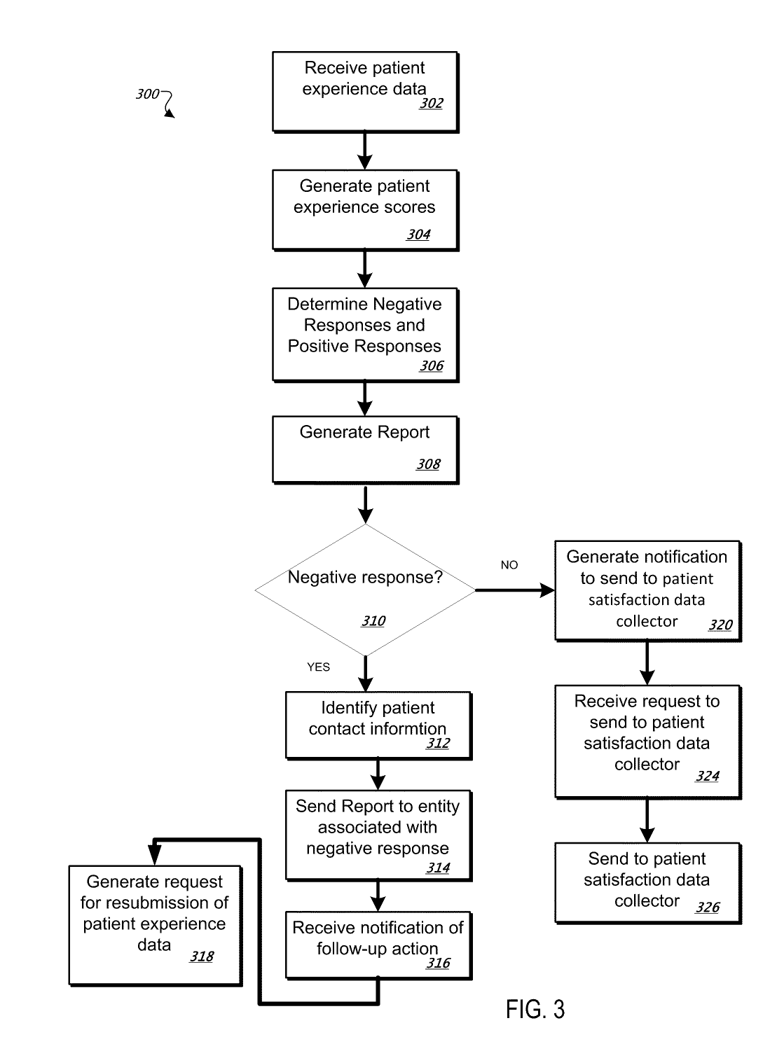

In an exemplary embodiment, server 102 includes analysis engine 110. Analysis engine 110 is configured to analyze patient experience data 108. In an example, analysis engine 110 is configured to determine whether patient experience data 108 includes information indicative of a positive patient experience (“positive response”) and/or indicative of a negative patient experience (“negative response”). Analysis engine 110 determines whether a patient's experience is a negative one or a positive one by generating patient experience scores, as described in further detail with reference to FIG. 3. In an example, a positive response specifies that the patient has indicated that the patient's experience is rated above a predefined threshold. In this example, patient experience data 108 may include answers to a number of “Yes/No” multiple choice questions. Analysis engine 110 is configured to determine a number of questions for which the patient answered “yes.” If the number of questions for which the patient answered “yes” (e.g., the patient experience score) is equal to or greater than a predefined number (e.g., five, ten, twenty, and so forth), analysis engine 110 grades patient experience data 108 as a positive response. Alternatively, if the patient experience score (e.g., the number of questions for which the patient answered “yes”) is less than the predefined number, analysis engine 110 grades patient experience data 108 as a negative response.

In another example, analysis engine 110 is configured to scan patient experience data 108 for certain keywords that are indicative of a positive response and/or are indicative of a negative response. In this example, the keywords indicative of a negative response may include the following words: bad, poor, negative, sick, no improvement, hurt, pain, relapse, and so forth. The keywords indicative of a positive response may include the following words: good, positive, nice, well, improved, ease, and so forth.

In still another example, analysis engine 110 may be configured to generate patient experience scores (e.g., real-time patient experience scores, instant patient experience scores and feedback, immediate patient experience scores, and so forth) by assigning a value to portions of patient experience data 108, including for example answers to questions, and then applying a regression (e.g., a weighted regression) to the assigned values. By doing so, analysis engine 110 is configured to assign a greater importance (e.g., weight) to portions of patient experience data. Analysis engine 110 may assign values to portions of patient experience data 108 based on keywords included in the portions of patient experience data 108, e.g., based on a “yes” or “no” answer to a question, and so forth. In the example of FIG. 1, analysis engine 110 tags (e.g., associates) patient experience data 108 as including a positive response or a negative response. In this example, when analysis engine 110 determines that patient experience data 108 includes a positive response, patient experience data 108 is associated with positive response tag 112. When analysis engine 110 determines that patient experience data 108 includes a negative response, patient experience data 108 is associated with negative response tag 114.

In an exemplary embodiment described herein, system 100 also includes a data repository, including, e.g., patient experience data repository 116. In an example, patient experience data repository 116 is secure and Health Insurance Portability and Accountability Act (“HIPPA”) compliant. Analysis engine 110 is configured to store in patient experience data repository 116 patient experience data 108, information indicative of whether patient experience data 108 is associated with positive response tag 112 and/or negative response tag 114.

In the example of FIG. 1, patient experience data 108 is associated with negative response tag 114. In this example, analysis engine 110 is configured to generate an alert that notifies the healthcare facility of the negative response tag 114 associated with patient experience data 108. In this example, the alert is displayed in the dashboard, as previously described. Additionally, through the dashboard, a member of the support staff may act on the alert, for example, by emailing and/or texting the patient to address the issue and to increase the user's satisfaction level.

Analysis engine 110 may send to a department that provided the healthcare patient experience data 108 associated with negative response tag 114, for example, to promote an ability of the department to address the situation that caused the patient's negative response. In an example, analysis engine 110 also sends to the department contact information for the patient, including, e.g., an email address, a telephone number, and so forth. Using the received contact information, the department associated with the negative response may contact the patient in an effort to address the negative response. In this example, patient experience data 108 may include contact information for the patient. In another example, analysis engine 110 is configured to access a data repository to look-up contact information for the patient associated with the negative response. In this example, patient experience data 108 may include identifying information for the patient. Using the identifying information, analysis engine 110 accesses and retrieves contact information for the patient from the data repository.

Following the healthcare facility's addressing of the negative response, analysis engine 110 may generate a request for resubmission of patient experience data in which the patient may submit additional information relating to the patient's experience after the healthcare facility has attempted to address the situation. In the example of FIG. 1, a patient uses client device 106 to send resubmitted patient experience data 118 to server 102. Server 102 receives resubmitted patient experience data 118 (e.g., via a patient satisfaction survey and/or questionnaire) and determines whether resubmitted patient experience data 118 is associated with a positive response or a negative response, and tags resubmitted patient experience data 118 accordingly. If resubmitted patient experience data 118 is tagged with positive response tag 112, analysis engine 110 may prompt the patient to submit resubmitted patient experience data 118 to a patient satisfaction data collector (e.g., HealthGrade™) Generally, a patient satisfaction data collector includes an entity that collects medical data pertaining to a patient's satisfaction with a healthcare facility, a physician, a healthcare professional, and so forth.

In an exemplary embodiment described herein, the patient satisfaction data collector may be part of and/or internal to system 100. The patient satisfaction data collector may also be external to system 100. In the example of FIG. 1, patient experience data repository 116 sends resubmitted patient experience data 118 associated with positive response tag 112 to client device 106, which is associated with an external patient satisfaction data collector. In another example, server 102 (and/or a component thereof) may send resubmitted patient experience data 118 associated with positive response tag 112 to client device 106.

In an example, patient experience data 108 may be associated with both negative response identifier 114 and positive response identifier 112, for example, a portion of patient experience data 108 includes a positive response, and another portion of patient experience data 108 includes a negative response. In this example, the portion of patient experience data 108 associated with the negative response is sent to the department in the healthcare facility that provided that healthcare associated with the negative response.

In an example, server 102 is configured to determine which users (e.g., patients) are qualified to fill out a questionnaire pertaining to the user's satisfaction level with the healthcare facility. Server 102 is also configured to determine a data and a time in which the user is qualified to fill out the questionnaire. In an example, server 102 is configured to determine that users who are qualified to fill out a questionnaire pertaining to surgery are users who have had a surgical experience with the healthcare facility in the last week. By doing so, server 102 is configured to guard against a questionnaire being sent to the user three months after the user has had surgery and may no longer remember whether the user's experience with the surgical facility was a positive one or a negative one.

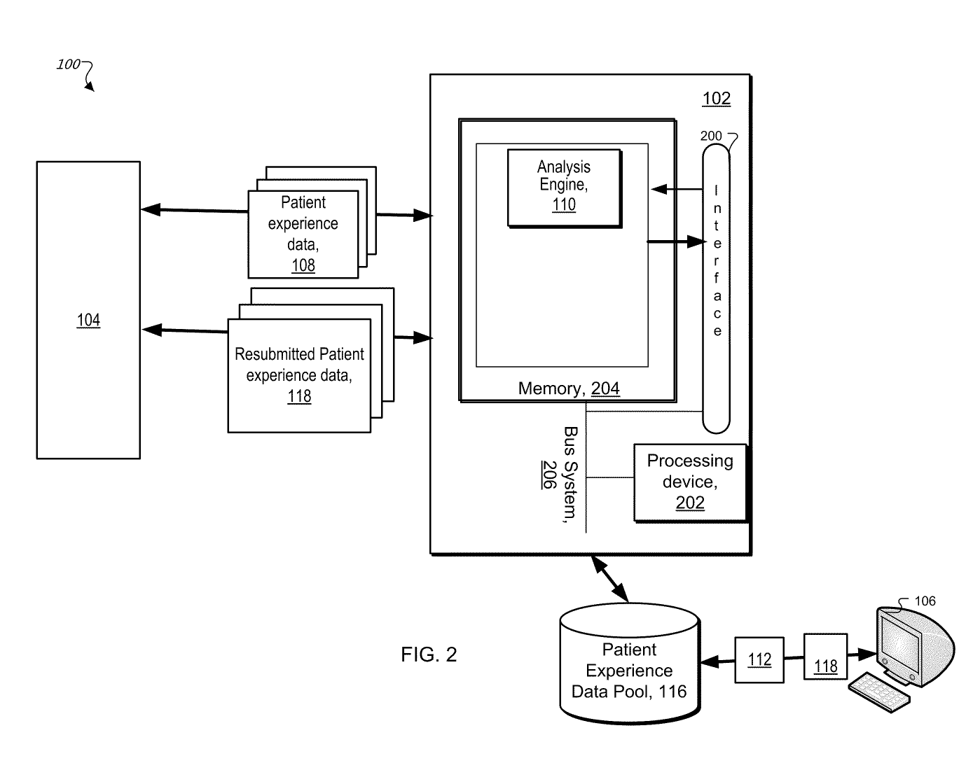

FIG. 2 illustrates a particular exemplary embodiment described herein. In particular, FIG. 2 is a block diagram of components of system 100 that tracks patient satisfaction levels within a healthcare facility. In the example of FIG. 2, reference number 114 is not shown. Client devices 104, 106 can be any sort of computing devices capable of taking input from a user and communicating over a network (not shown) with server 102 and/or with other client devices. For example, client devices 104, 106 can be mobile devices, desktop computers, laptops, cell phones, personal digital assistants (“PDAs”), servers, embedded computing systems, and so forth.

In the exemplary embodiment of FIG. 2, server 102 can be any of a variety of computing devices capable of receiving information, such as a server, a distributed computing system, a desktop computer, a laptop, a cell phone, a rack-mounted server, and so forth. Server 102 may be a single server or a group of servers that are at a same location or at different locations.

Server 102 can receive information from client device 104 via input/output (“I/O”) interface 200. I/O interface 200 can be any type of interface capable of receiving information over a network, such as an Ethernet interface, a wireless networking interface, a fiber-optic networking interface, a modem, and so forth. Server 102 also includes a processing device 202 and memory 204. A bus system 206, including, for example, a data bus and a motherboard, can be used to establish and to control data communication between the components of server 102.

In the exemplary embodiment of FIG. 2, processing device 202 may include one or more microprocessors. Generally, processing device 202 may include any appropriate processor and/or logic that is capable of receiving and storing data, and of communicating over a network (not shown). Memory 204 can include a hard drive and a random access memory storage device, such as a dynamic random access memory, or other types of non-transitory machine-readable storage devices. As shown in FIG. 2, memory 204 stores computer programs that are executable by processing device 202. Among these computer programs is analysis engine 110.

FIG. 3 illustrates a particular exemplary embodiment described herein. In particular, FIG. 3 is a flow chart of process 300 that tracks patient satisfaction levels within a healthcare facility. In operation, analysis engine 110 receives (302) patient experience data 108. In an example, analysis engine 110 receives patient experience data 108 through a telephonic communication, through an electronic mail communication, and/or through the system described in U.S. application Ser. No. 12/699,522. Analysis engine 110 generates (304) patient experience scores, for example, by determining values for portions of patient experience data 108 and determining whether the values exceeds a predefined threshold, as previously described.

In the illustrative example of FIG. 3, analysis engine 110 determines (306) negative responses and/or positive responses in patient experience data 108, for example, by determining which portions of patient experience data 108 are associated with patient experience scores above the predefined threshold and which portions of patient experience data 108 are below the predefined threshold. In an example, the portions of patient experience data 108 associated with a negative response are tagged with negative response tag 114. The portions of patient experience data 108 associated with a positive response are tagged with positive response tag 112.

In the exemplary embodiment of FIG. 3, analysis engine 110 generates (308) a report that translates patient experience data 108 into an easy to read format. In an example, the report may be accessed and viewed by administrators of a healthcare facility, healthcare clinics, the general public, and so forth (collectively referred to herein as “report viewers,” without limitation, for purposes of convenience). Using the report, report viewers may determine which areas (e.g., departments, medical procedures, staff, and so forth) of a healthcare facility are performing at a satisfactory level and which departments, medical procedures and areas of the healthcare facility are performing below a satisfactory level. In an example, an area of a healthcare facility is determined to be performing at a satisfactory level if a majority of patient experience data associated with the area of the healthcare facility is associated with a positive response tag.

Analysis engine 110 determines (310) whether patient experience data 108 (or a portion thereof) is associated with positive response tag 112 or negative response tag 114. If patient experience data 108 is associated with negative response tag 114, analysis engine 110 identifies (312) patient contact information, for example, as previously described.

In the exemplary embodiment of FIG. 3, analysis engine 110 sends (314) to an entity within a healthcare facility associated with the medical service (and/or procedure) that caused the negative response the generated report along with the identified contact information. The entity may include a healthcare administrator, a physician, an individual designated to receive the report, and so forth. Analysis engine 110 sends the entity the patient's contact information to facilitate the entity contacting the patient to address the issue that caused the negative response. In an example, a patient is contacted through text messages, email messages and/or the telephone, until the problem is resolved. In another example, analysis engine 110 is configured to generate an automated response following detection of a negative response in patient experience data 108. In an example, the automated response provides the patient with suggested actions the patient may take to improve the patient's situation, suggested reading materials, suggested online help centers, and so forth.

In an example, the healthcare facility may perform follow-up actions to increase the patient's satisfaction level, including, e.g., providing the patient with a follow-up visit, having a physician contact the patient to discuss the patient's medical condition, and so forth. In this example, subsequent to performance of the follow-up actions, the healthcare facility sends to server 102 a notification of the follow-up actions. Analysis engine 110 receives (316) the notification of the follow-up action.

In response, analysis engine generates (318) a request for resubmission of patient experience data, as previously described. The request for resubmission of patient experience data includes a notification that asks the patient whether the patient would like to resubmit patient experience data that reflects the patient's improved response. The request for resubmission of patent experience data is sent to the client, for example, through client device 104.

In an example, the patient resubmits patient experience data, for example, by sending resubmitted patient experience data 118 to server 102. In this example, the actions of FIG. 3 are re-performed to determine whether the patient's satisfaction level has increased.

Still referring to FIG. 3, when analysis engine 110 determines (310) that patient experience data 108 is associated with a positive response, analysis engine generates (320) a notification to send the patient experience data associated with the positive response to a patient satisfaction data collector. In an example, the notification is sent to a client through client device 104.

If the patient chooses to submit the patient experience data associated with the positive response, the patient may send to server 102 a request to send the patient experience data to the patient satisfaction data collector. In an example, analysis engine 110 receives (324) from client device 104 a request to send the patient experience data to the patient satisfaction data collector. In this example, analysis engine 110 sends (326) the patient experience data to the patient satisfaction data collector,

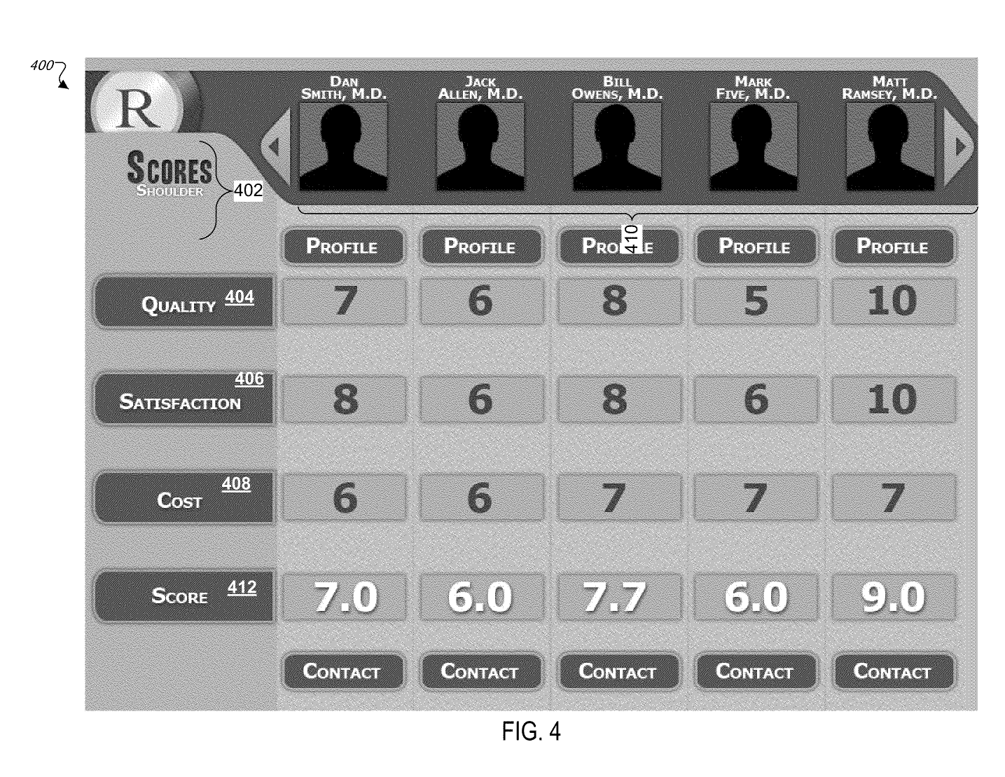

FIG. 4 illustrates a particular exemplary embodiment described herein. In particular, FIG. 4 includes an example graphical user interface 400 generated by analysis engine 110 using patient experience data 108. In the example of FIG. 4, section 402 specifies the medical procedure (e.g., medical procedures on shoulders) that is being scored. Analysis engine 110 uses patient experience data 108 to determine patient's satisfaction with physician's performing shoulder procedures. Analysis engine 110 scores patient satisfaction based on various criteria, including, e.g., quality scores 404, satisfaction scores 406 and cost scores 406. Analysis engine 110 also generates the scores for individual physicians, as indicated in section 410 of graphical user interface 400. Analysis engine 110 generates for each physician an overall score indicative of patients' satisfaction with the physician for shoulder procedures, for example, as indicated by section 412 of graphical user interface 400. The overall score may include an average of the quality scores 404, satisfaction scores 406 and cost scores 408.

In an example, analysis engine 110 is configured to generate quality scores 404 based on information included in patient experience data 108. In this example, patient experience data 108 may include a quality question (e.g., Please rate on a scale of 1-10 the quality of this physician.”) Analysis engine 110 may generate an overall quality score for a physician by generating an average of all the quality scores received for the physician for the particular medical procedure. Using a similar technique, analysis engine 110 may generate satisfaction scores 406 and cost scores 408.

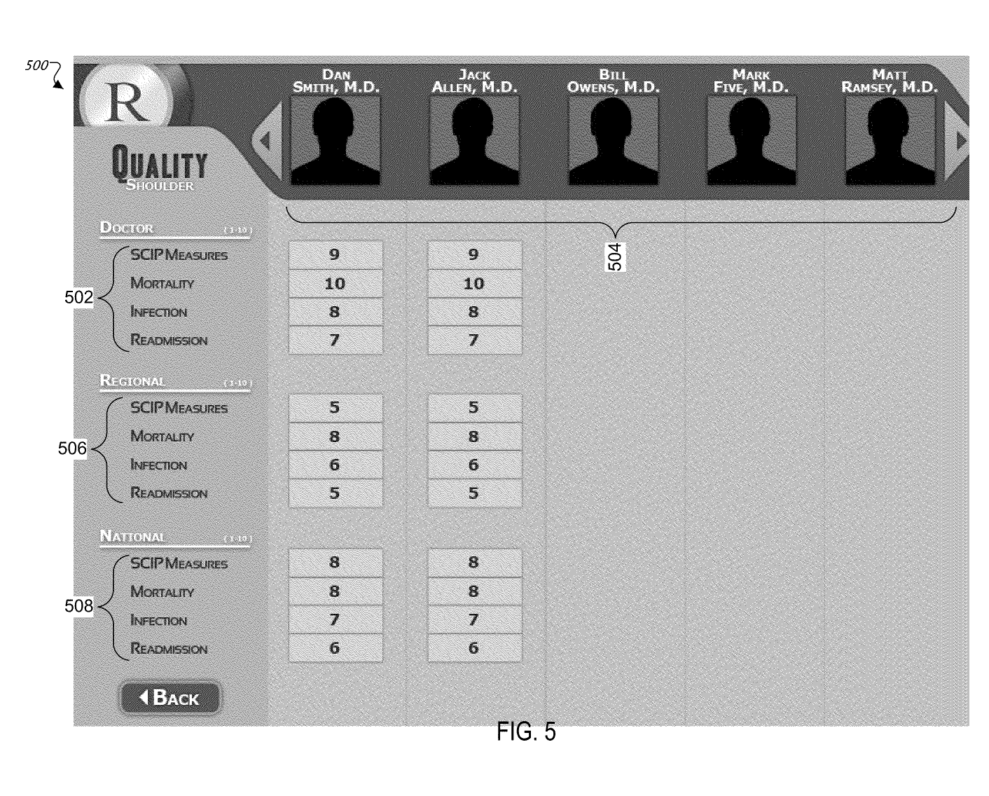

FIG. 5 illustrates a particular exemplary embodiment described herein. In particular, FIG. 5 includes an example graphical user interface 500 of regional and national metrics calculated from patient experience data 108. In the example of FIG. 5, analysis engine 110 uses patient experience data 108 to generate physician-specific metrics 502. Additionally, analysis engine 110 is configured to calculate physician-specific metrics 502 for individual physicians, as indicated in section 504 of graphical user interface 500. Physician-specific metrics 502 include information specifying patients' cumulative satisfaction with a physician in a particular area, for a particular procedure, for a particular skill level and so forth.

Analysis engine 110 is also configured to generate regional metrics 506 and national metrics 508, for example, for physicians based on patient experience data 108. In an example, regional metrics 506 include information specifying patients' satisfaction with a physician that have been aggregated across a regional geographical area (e.g., a county, a city, a state, and so forth). National metrics 508 include information specifying patients' satisfaction with a physician that have been aggregated at a national level.

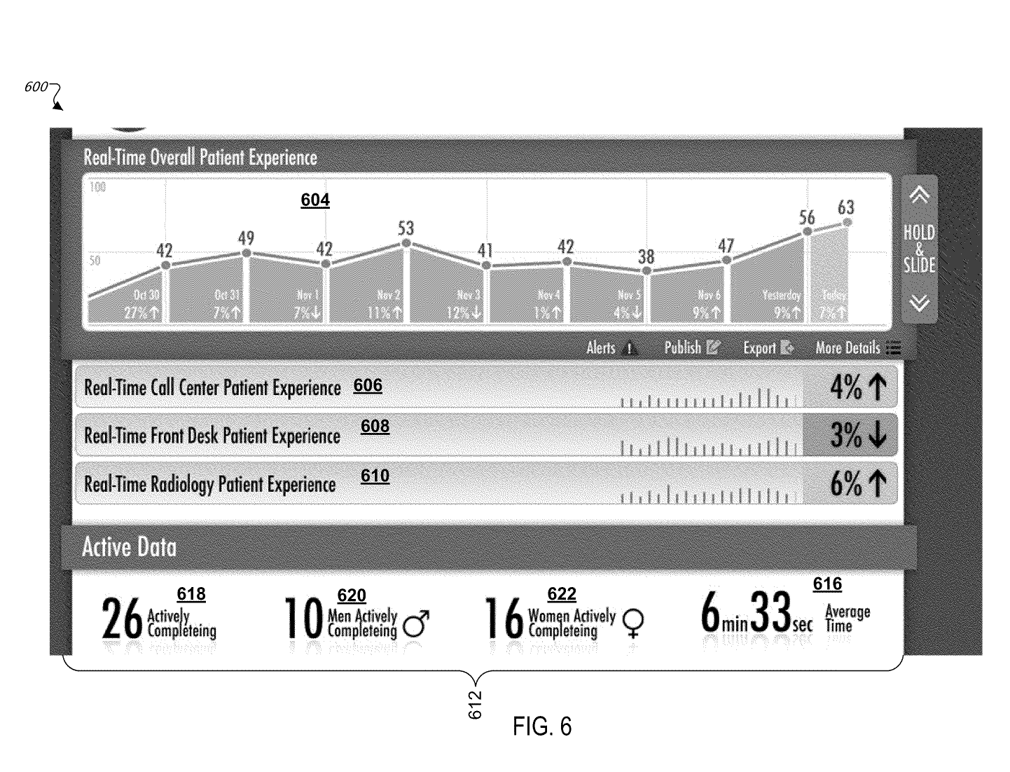

FIG. 6 illustrates a particular exemplary embodiment described herein. In particular, FIG. 6 includes an example graphical user interface 600 of a report generated by analysis engine 110. In particular, graphical user interface 600 displays information indicative of patients' satisfaction levels with a healthcare facility. Section 602 includes information indicative of patients' satisfaction level with the healthcare facility over a number of days. In particular, for each day, analysis engine 110 is configured to calculate whether the satisfaction level has increased or decreased with regard to the satisfaction of the prior day. For example, section 604 indicates that patient's satisfaction level have decreased by 12% with regard to the prior day's satisfaction levels.

In an exemplary embodiment described herein, sections 606, 608, 610 include information indicative of patient satisfaction levels for various areas of the healthcare facility, including, e.g., the call center, the front desk and the radiology department. In an example, analysis engine 110 is configured to determine which area of a healthcare facility patient experience data 108 (or a portion thereof) pertains to. In this example, analysis engine 110 does so by parsing patient experience data 108 for terms indicative of an area of the healthcare facility. In an example, patient experience data includes the sentence “the front desk was very slow.” In this example, using the inclusion of the words front desk in the patient experience data, analysis engine determines the portion of patient experience data 108 that is related to the front desk area of the healthcare facility.

In the exemplary embodiment described herein, section 612 of graphical user interface 600 includes information specifying data collected while tracking patient's satisfaction level with a medical service and/or procedure. In an example, section 612 includes information (not shown) specifying a number of patients that have expressed dissatisfaction with the healthcare facility. In this example, the dissatisfaction information includes a selectable link, selection of which displays for a user the medical procedures (and/or services) that caused the patient's dissatisfaction.

Section 612 also includes information 616 specifying an average amount of time it took the healthcare facility to address the patient's dissatisfaction. Section 612 also includes information (not shown) specifying a percentage of patients who are satisfied with the level of received medical care. Section 612 also includes information 618, 620, 622, specifying a cumulative number of patients that are completing satisfaction surveys, a number of male patients that are completing satisfaction survey, and a number of female patients that are completing satisfaction surveys.

In another exemplary embodiment, a patient is sent a questionnaire that asks the patient to score one or more of the following assessments: ease of scheduling appointment, friendliness and warmth of person who scheduled the appointment, overall service you received over the telephone from the scheduling staff, greeting you received from the front desk when you arrived for your appointment, friendliness and warmth of the front desk staff, ease of registration process, appearance of the front desk staff, professionalism of the front desk staff, overall service you received from the front desk staff, greeting you received from the nurse or medical assistant escorting you to your exam room, friendliness and warmth of the nurse or medical assistant, professionalism of the nurse or medical assistant, appearance of the nurse or medical assistant, overall service you received from the nurse or medial assistant, greeting you received from your physician, friendliness and warmth of the physician, appearance of the physician, professionalism of the physician, overall service you received from the physician, and so forth. For example, the foregoing assessments may also be asked with regard to physical therapy staff, billing personnel, schedulers, and overall for the health care facility.

In the foregoing example, a patient is provided a selection of answer choices for each assessment, including, e.g., poor, fair, good, very good and excellent. For each assessment, the system described herein is configured to provide information indicative of a total number of patients that provided an answer for the assessment. The system is also configured to determine a percentage of patients that scored an assessment with a poor value, with a fair value, with a good value, with a very good value, with an excellent assessment, and so forth. In an example, the system is also configured to generate statistics indicative of an average score for an assessment, a standard deviation value for an assessment, and so forth.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer readable media for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry. Any of the foregoing can be supplemented by, or incorporated in, ASICs (application-specific integrated circuits).

To provide for interaction with a user, embodiments can be implemented on a computer having a display device, e.g., a LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

The system and method use the “World Wide Web” (Web or WWW), which is that collection of servers on the Internet that utilize the Hypertext Transfer Protocol (HTTP). HTTP is a known application protocol that provides users access to resources, which may be information in different formats such as text, graphics, images, sound, video, Hypertext Markup Language (HTML), as well as programs. Upon specification of a link by the user, the client computer makes a TCP/IP request to a Web server and receives information, which may be another Web page that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments using web pages to allow a user to select options for a given component. Servers run on a variety of platforms, including UNIX machines, although other platforms, such as Windows 2000/2003, Windows NT, Sun, Linux, and Macintosh may also be used. Computer users can view information available on servers or networks on the Web through the use of browsing software, such as Firefox, Netscape Navigator, Microsoft Internet Explorer, or Mosaic browsers. The computing system can include clients and servers. A client and server are generally remote from each other and typically interact through a communication network. The relationship of client and server arises by virtue of computer programs running on the respective computers and having a client-server relationship to each other.

Other embodiments are within the scope and spirit of the description claims. In one embodiment, the rules described herein (e.g., the procedure determination rules or the medical assessment rules) are executed by a rules engine included in the system 102. In another embodiment, data collected by the system 102 through the instruments is stored in an EMR system 128. The research tool may then query the EMR system 128 for patient data matching one or more patient criteria. Through the network 112, the matching data is returned to the system 102 and the research tool processes and analyzes the returned data. In yet another embodiment, the techniques described herein are used to generate, review and validate instruments pertaining to various fields (e.g., the veterinary field, the legal field and the financial services field) and collect and retrieve data for the instruments pertaining to the various fields. In still another embodiment, the instrument generation module 116, the instrument validation module 118, the research tools module 120, the procedure determination module 122 and the patient flow module 124 are integrated together through various communication channels and/or are implemented as an instrument generation system, an instrument validation system, a research tools system, a procedure determination system and a patient flow system (collectively referred to as “the systems” herein, without limitation, for the purposes of convenience), with each system including one or more servers or computing devices and the systems being integrated together through various communication channels and/or network connections.

Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

What is claimed is:

1. A computer-implemented method comprises:
tracking by one or more computer systems a user's satisfaction level with a medical service;
determining by the one or more computer systems that the user's satisfaction level is below a threshold value;
causing by the one or more computer systems one or more processes to be implemented to increase the user's satisfaction level above the threshold value;
determining by the one or more computer systems that the user's satisfaction level is above the threshold value; and
causing by the one or more computer systems information indicative of the user's satisfaction level to be sent to a data reporting system.

2. The computer-implemented method of claim 1, wherein the one or more processes comprise:
notifying an entity associated with the medical service that the user's satisfaction level with the medical service is below the threshold value.

3. The computer-implemented method of claim 2, further comprising:
receiving a notification that the entity has performed one or more follow-up actions to increase the user's satisfaction level with the medical service.

4. The computer-implemented method of claim 3, further comprising:
sending, to a computer system associated with the user, a request for the user to re-submit information indicative of the user's satisfaction level with the medical service.

5. The computer-implemented method of claim 1, further comprising:
generating, by the one or more computer systems, a user satisfaction survey;
sending, by the one or more computers, the user satisfaction survey to the user that received the medical service; and
receiving information indicative of answers to questions included in the user satisfaction survey.

6. The computer-implemented method of claim 5, wherein determining by the one or more computer systems that the user's satisfaction level is below the threshold value comprises:
analyzing by the one or more computers information included in the user satisfaction survey;
determining that at least a portion of the information included in the user satisfaction survey pertains to the medical service;
generating a quality score for the portion of the information that pertains to the medical service;
comparing the quality score to the threshold value; and
determining, based on comparing, that the quality score is below the threshold value.

7. An electronic system comprising:
one or more processing devices; an
one or more machine-readable media configured to store instructions that are executable by the one or more processing devices to perform operations comprising:
tracking a user's satisfaction level with a medical service;
determining that the user's satisfaction level is below a threshold value;
causing one or more processes to be implemented to increase the user's satisfaction level above the threshold value;
determining that the user's satisfaction level is above the threshold value; and
causing information indicative of the user's satisfaction level to be sent to a data reporting system.

8. The electronic system of claim 7, wherein the one or more processes comprise:
notifying an entity associated with the medical service that the user's satisfaction level with the medical service is below the threshold value.

9. The electronic system of claim 8, wherein the operations further comprise:
receiving a notification that the entity has performed one or more follow-up actions to increase the user's satisfaction level with the medical service.

10. The electronic system of claim 9, wherein the operations further comprise:
sending, to a computer system associated with the user, a request for the user to re-submit information indicative of the user's satisfaction level with the medical service.

11. The electronic system of claim 7, wherein the operations further comprise:
generating, by the one or more computer systems, a user satisfaction survey;
sending, by the one or more computers, the user satisfaction survey to the user that received the medical service; and
receiving information indicative of answers to questions included in the user satisfaction survey.

12. The electronic system of claim 11, wherein determining that the user's satisfaction level is below the threshold value comprises:
analyzing by the one or more computers information included in the user satisfaction survey;
determining that at least a portion of the information included in the user satisfaction survey pertains to the medical service;
generating a quality score for the portion of the information that pertains to the medical service;
comparing the quality score to the threshold value; and
determining, based on comparing, that the quality score is below the threshold value.

13. One or more machine-readable media configured to store instructions that are executable by one or more processing devices to perform operations comprising:
tracking a user's satisfaction level with a medical service;
determining that the user's satisfaction level is below a threshold value;
causing one or more processes to be implemented to increase the user's satisfaction level above the threshold value;
determining that the user's satisfaction level is above the threshold value; and
causing information indicative of the user's satisfaction level to be sent to a data reporting system.

14. The one or more machine-readable media of claim 13, wherein the one or more processes comprise:
notifying an entity associated with the medical service that the user's satisfaction level with the medical service is below the threshold value.

15. The one or more machine-readable media of claim 14, wherein the operations further comprise:
receiving a notification that the entity has performed one or more follow-up actions to increase the user's satisfaction level with the medical service.

16. The one or more machine-readable media of claim 13, wherein the operations further comprise:
sending, to a computer system associated with the user, a request for the user to re-submit information indicative of the user's satisfaction level with the medical service.

17. The one or more machine-readable media of claim 13, wherein the operations further comprise:
generating, by the one or more computer systems, a user satisfaction survey;
sending, by the one or more computers, the user satisfaction survey to the user that received the medical service; and
receiving information indicative of answers to questions included in the user satisfaction survey.

18. The one or more machine-readable media of claim 17, wherein determining that the user's satisfaction level is below the threshold value comprises:
analyzing by the one or more computers information included in the user satisfaction survey;
determining that at least a portion of the information included in the user satisfaction survey pertains to the medical service;
generating a quality score for the portion of the information that pertains to the medical service;
comparing the quality score to the threshold value; and
determining, based on comparing, that the quality score is below the threshold value.
